(19) United States
(12) Patent Application Publication
(10) Pub. No.: US 2019/0300359 A1
(43) Pub. Date: Oct. 3, 2019

(54) LIQUID CONTAINER END PIECE INTENDED TO BE FITTED ON A TANK END PIECE

(71) Applicant: Total Marketing Services, Puteaux (FR)

(72) Inventors: François MARTIN, Garches (FR); Laurent SIBUE, Versailles (FR); Agnès ROBIN, Larmor (FR); Jean Christophe MONIN, Moissy-Cramayel (FR); François BURON, Le Pecq (FR); Damien RAGONNEAU, Saint Germain du Seudre (FR)

(73) Assignee: Total Marketing Services, Puteaux (FR)

(21) Appl. No.: 16/304,557

(22) PCT Filed: May 24, 2017
(86) PCT No.: PCT/EP2017/062619

§ 371 Date: Nov. 26, 2018

(30) Foreign Application Priority Data
May 25, 2016 (FR) 1654677

(51) Int. Cl. B67D 7/00; B65D 25/38

(52) U.S. Cl. CPC B67D 7/005; B65D 25/38

(57) ABSTRACT

A container end piece has: an inlet; an outlet; a closure device that is movable between a closed position and an open position; and a connection device for connecting the container end piece on to the tank end piece. The connecting device has: a clamping device that is movable between a spaced-apart position, in which the container end piece can be inserted around the tank end piece, and a clamped position, in which the clamping device co-operates with the tank end piece; and a control device that is actuable between a retracted position and an active position, in which the control device exerts a clamping force on the clamping device in its clamped position.

### RELATED APPLICATIONS

The present application is a U.S. National Stage application of International PCT Application No. PCT/EP2017/062619 filed on May 24, 2017 which claims priority benefit of French Application No. FR 16 54677 filed on May 25, 2016, the contents of each are incorporated by reference in their entirety.

### FIELD OF THE INVENTION

The present invention relates to a liquid container end piece, of the type intended to be fitted on a liquid tank end piece in order to transfer in a sealed manner the liquid from the container to the tank, the said container end piece comprising:
an inlet intended to be connected in a sealed manner to the liquid container;
an outlet intended to be connected in a sealed manner to the tank end piece, the said outlet being in fluid communication with the inlet;
a movable closure device that is movable between a closed position, in which the closure device prevents the flow of liquid through the outlet, and an open position in which the closure device allows the flow of liquid through the outlet;
a sealed connection device for sealingly connecting the container end piece on to the tank end piece that is intended to cooperate in a sealed and detachable manner with the tank end piece.

The invention also relates to a connection assembly for connecting a liquid container to a liquid tank, comprising such a container end piece and a liquid container comprising such a container end piece.

### BACKGROUND OF THE INVENTION

For the transfer of certain liquids between a container containing this liquid and a tank to be filled with this liquid, it may be necessary to ensure a sealed connection between the container and the tank in order to prevent any leakage of liquid outside the tank during the course of the transfer. This is particularly the case for toxic or dangerous liquids, liquids that must not be exposed to air or to the ambient environment in order to avoid the risk of pollution of the liquids by this environment or the pollution of the environment by these liquids, the liquids producing unpleasant or noxious fumes or more simply when the transfer of liquid is to be carried out at a pressure other than atmospheric pressure or so as to ensure a transfer of liquid in a lossless and/or simple manner, rapidly and/or ergonomically.

In addition, this sealed connection is generally to be provided in order to avoid unintentional disconnection, which could lead to a leakage of liquid.

In order to ensure a sealed transfer, there is provided a container end piece connected to the container and adapted so as to cooperate with the end piece of the tank in a manner so as to ensure a sealed connection between the internal volume of the container and the internal volume of the tank. For this purpose, the container end piece is generally screwed on to a thread provided on the external wall of the end piece of the tank. This connection is particularly robust and sealed.

However, the operation of screwing the container end piece on to the tank end piece is a tedious operation and can be complicated if the tank end piece is difficult to access. In addition, the sizing of the thread of the container end piece must be appropriately adapted to that of the tank end piece. Thus, the container end piece cannot be used with all types of tank end piece.

The document AU 646 972 B2 discloses a liquid pipe end piece of the aforementioned type, wherein the connecting device comprises locking ball bearings and an actuating slider.

The retaining in the connected position is done by the cooperation of the connection device with the complementary receiving means provided on the pipe end piece.

### SUMMARY OF THE INVENTION

One of the aims of the invention is to overcome these disadvantages by providing a tank end piece that has the ability to be connected simply, rapidly and/or ergonomically in a sealed and secure manner on to a container end piece.

To this end, the invention relates to a container end piece of the aforementioned type, comprising:
a clamping device around the tank end piece that is movable between a spaced-apart position, in which the container end piece can be inserted around an external wall of the tank end piece, and a clamped position, in which the clamping device co-operates in a sealed manner with the external wall of the tank end piece,
a control device that is actuable between a retracted position, in which the control device does not cooperate with the clamping device, and an active position, in which the control device exerts a clamping force on the clamping device in its clamped position, the movement of the control device from the retracted position to the active position causing the moving of the clamping device from the spaced-apart position to the clamped position.

The container end piece according to the invention can be attached on to a tank end piece by simply press fitting the container end piece on to the tank end piece and actuating the control device in order to cause the moving of the clamping device from the spaced-apart position to the clamped position. This movement of press fitting and actuation can be brought about thanks to a single translational movement and therefore does not necessitate the effecting of a rotation of the container end piece as is the case when the container end piece is screwed on to the tank end piece. Thus, the connection operation is faster and simplified. This connection may in particular be carried out with only one hand. In addition, the connection does not require positioning the container end piece according to a particular orientation in relation to the tank end piece. In addition, the container end piece can be attached to a smooth section of the tank end piece. It is thus not necessary to provide for the container end piece to fit in any particular manner on to the tank end piece.

In the pipe end piece described in the document AU 646 972 B2, the actuating slide moves the locking ball bearings into a receiving groove provided on the pipe end piece but does not exert a clamping force on these ball bearings in order to retain them in the groove. This difference allows the end piece according to the present invention to cooperate in an effective manner with a tank end piece having a smooth external wall and not including specific receiving means.

According to other characteristic features of the container end piece according to the invention, taken into consideration separately or in accordance with any technically possible combination:
the outlet extends along an axis of flow, the movement of the clamping device between the spaced apart position and the clamped position being effected along a radial direction, that is substantially perpendicular to the direction of the axis of flow;
the control device moves in translational motion along the axis of flow between the retracted position and the active position;
the control device is connected to the closure device, the control device being in addition actuable in a flow position beyond the active position in relation to the retracted position, the movement of the control device in the flow position causing the closure device to move from the closed position to the open position;
the control device comprises a locking device for locking the control device in the flow position, the locking device being movable between an unlocked position when the control device moves between the retracted position and the flow position, and a locked position when the control device reaches the flow position, the locking device being arranged so as to retain the control device in the flow position when it is in the locking position:
the clamping device comprises at least two clamping arms, preferably oppositely arranged, spaced apart from each other in the spaced-apart position and drawn close to one another in the clamped position, each clamping arm comprising of an internal surface adapted so as to be in sealed contact with the external wall of the tank end piece in the clamped position, and an external surface on which the control device slides while moving from the retracted position to the active position in a manner so as to draw the clamping arms close to one another during this movement;
the container end piece comprises a wall extending between the inlet and the outlet and defining a portion of a liquid flow volume, the closure device comprising a movable body provided with a closure body, the movable body being movable in relation to the said wall between the closed position in which the closure body is in sealing contact with the wall and the open position, in which the closure body is disengaged from the wall in a manner such that the liquid is able to flow through the outlet;
the container end piece comprises an aeration duct extending through the flow volume and insulated from it, the said duct comprising at least one air inlet integrally formed with the closure body in a manner such that the air inlet is closed in the closed position of the closure device and is in communication with the exterior in the open position of the closure device;
the container end piece in addition comprises a locking device, that is movable between a locking position, in which the locking device prevents the moving of the closure device from the closed position to the open position, and an unlocking position, in which the closure device is able to move between the open and closed positions;
the locking device comprises a cap that is fixed on to a wall of the container end piece and prevents the moving of the closure device in the locking position and separated from the said wall in the unlocking position; and
the locking device comprises at least one locking tab, the said locking tab being movable between a locking position, in which it interferes with the closure device and prevents its movement, and an unlocking position, in which the locking tab does not interfere with the closure device and allows its movement, the moving of the locking tab from the locking position to the unlocking position being brought about by the introduction of the container end piece on the tank end piece.

The invention also relates to a connection assembly for connecting a liquid container to a liquid tank, comprising a container end piece as described here above and a tank end piece comprising an external wall of which at least one section is substantially smooth, the container end piece being attached in a sealed manner to the tank end piece by the cooperation of the clamping device with the smooth section of the external wall when the said clamping device is in the clamped position.

The invention also relates to a liquid container that defines an internal volume that is adapted so as to contain a liquid and comprises an outlet opening through which the liquid can flow out of the internal volume, the said container comprising a container end piece as described here above whereof the inlet is in fluid communication with the internal volume of the container by way of the outlet opening.

According to another characteristic feature, the liquid container comprises a neck defining the outlet opening, the container end piece being fixed directly on to the said neck or being connected to the said neck by means of a flexible pipe.

### BRIEF DESCRIPTION OF THE FIGURES

Other aspects and advantages of the invention will become apparent upon reading the description which follows, given purely by way of example and with reference being made to the appended drawings, in which:

FIG. 1 is a schematic representation in perspective view of a connection assembly comprising a container end piece according to the invention;

FIG. 2 is a schematic representation in cross sectional view along the axis II-II of the connection assembly shown in FIG. 1, the clamping device being in the spaced-apart position;

FIG. 3 is a schematic representation in cross sectional view along the axis III-III of the connection assembly shown in FIG. 1, the clamping device being in the spaced-apart position,

FIG. 4 is a schematic representation in cross sectional view of the connection assembly shown in FIG. 2, the clamping device being in the clamped position and the closure device being in the open position;

FIG. 5 is schematic representation in cross sectional view of the connection assembly shown in FIG. 3, the clamping device being in a clamped position and the closure device being in the open position;

FIG. 6 is a schematic representation in cross sectional view of a flexible pipe that is able to be used with the container end piece of the invention;

FIG. 7 is a schematic representation in cross sectional view of a container end piece comprising a locking device in the locked position according to one embodiment of the invention;

FIG. 8 is a schematic representation in cross sectional view of a container end piece comprising a locking device in the locked position according to another embodiment of the invention; and

FIG. 9 is a schematic representation in cross sectional view of the container end piece shown in FIG. 8, the locking device being in the unlocking position and the closure device being in the open position.

### DETAILED DESCRIPTION OF THE EMBODIMENTS

In the description, the terms “upstream” and “downstream” are defined in relation to the direction of flow of the liquid from a container to a tank along an axis of flow. The term “radial” is defined along a direction or a plane that is substantially perpendicular to the axis of flow. The term “exterior” is defined by that which extends outside of the volume defined by the container end piece.

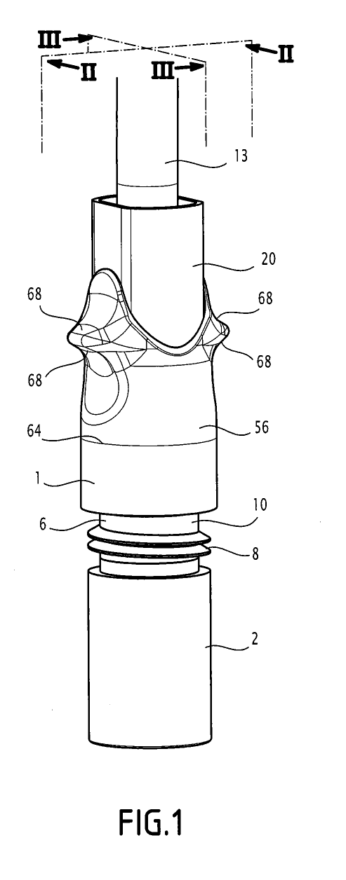

With reference to FIG. 1, a connection assembly for connecting a container to a tank is described. The terms ‘container’ and ‘tank’ (not shown) are used to refer to any type of liquid receptacle that defines an internal volume that is adapted so as to contain a liquid and comprises an opening for the flow of liquid (liquid flow opening) that is in fluid communication with the internal volume. More particularly, the invention relates to a connection assembly that makes it possible to pour or transfer a liquid from the container to the tank. Thus, the container is for example formed by a jerry can of any capacity, and the tank is for example formed by a vehicle tank. The invention is particularly suitable for transferring an aqueous urea solution from a jerry can to a motor vehicle tank. However, the container could also be formed by the tank of a pump or the like and the tank could be formed by another jerry can or the like.

The connection assembly comprises a container end piece 1, intended to be attached to the container in a manner so as to be in fluid communication with the liquid flow opening of the container, and a tank end piece 2, intended to be attached to the tank in a manner so as to be in fluid communication with the liquid flow opening of the tank.

The tank end piece 2 is, for example, integrally formed as a single piece with the tank and comprises an internal wall 4, forming a liquid flow channel in fluid communication with the flow opening, and an external wall 6, forming a receiving surface for receiving the container end piece 1 or a closure cap. The internal wall 4 and the external wall 6 are for example formed by cylinders of coaxial revolution and extending along an axis of flow A. The external wall 6 comprises for example a thread 8 intended to enable the attachment of a cap (not shown) The external wall 6 in addition comprises a smooth section 10 extending between the thread 8 and the free end 12 of the tank end piece 2. The term ‘smooth section’ 10 is understood as indicating that the external wall 6 is of substantially constant diameter in the smooth section 10. By way of example, the length of the smooth section 10, measured along the axis of flow A, is comprised between 5 mm and 10 mm, preferably between 6 mm and 9 mm and more preferably between 7 mm and 8 mm. According to one particular example, the length of the smooth section 10 measured along the axis of flow A is 7.8 mm.

The container end piece 1 is intended to be connected to the flow opening of the container. Advantageously, the container end piece is not integrally formed as a single piece with the container but is fixed on to the latter in a manner such that it can be removed. According to one embodiment that is suitable for small capacity jerry cans, the container end piece 1 is for example screwed on to the flow opening. By way of a variant, for example for larger capacity jerry cans, the container end piece 1 is connected to a flexible pipe 13 itself connected to the liquid flow opening, as represented in FIGS. 1 and 7 for example. The container end piece 1 is thus adapted accordingly, for example by being provided with a thread for screwing it on to a container or comprising a reception mouthpiece for receiving the flexible pipe in a sealed manner.

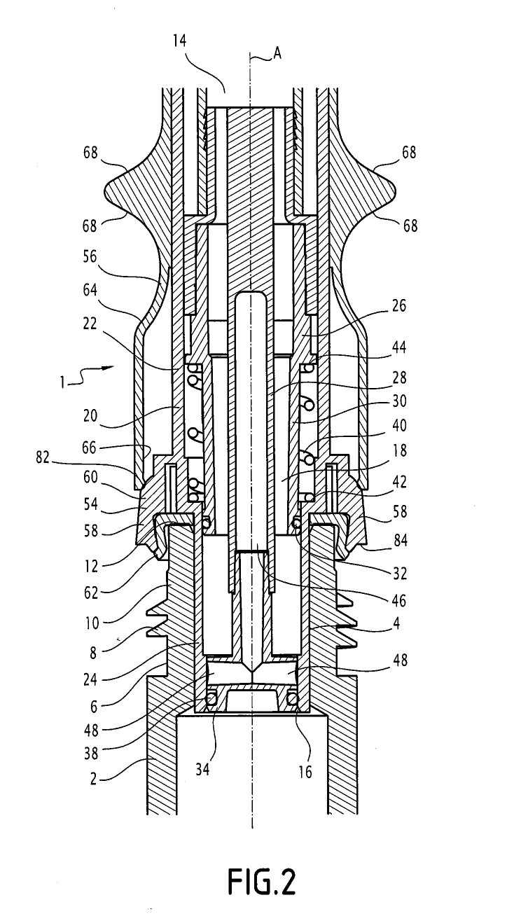

As represented in FIGS. 2 to 9, the container end piece comprises an inlet 14 and an outlet 16 that is in fluid communication with the inlet 14. The inlet 14 is in fluid communication with the flow outlet of the container in a manner such that the liquid contained in the container is able to flow to the outlet 16 passing through the inlet 14. In the case of a connection of the container end piece 1 with a flexible pipe 13, the inlet 14 is connected to a liquid flow pipe 17 provided in the flexible pipe 13, as represented in FIGS. 7 to 9. The inlet 14 and the outlet 16 are connected to each other by a flow volume 18 that is sealed, that is to say that a liquid disposed in the flow volume is able to flow out only through the inlet 14 or the outlet 16. When the container end piece 1 is connected to the tank end piece 2 as will be described further on, the flow volume 18, the inlet 14 and the outlet 16 extend substantially along the axis of flow A.

The container end piece 1 comprises a fixed body 20 comprising of a wall 22. In the vicinity of the outlet 16, the flow volume 18 is delimited by the downstream portion 24 of the wall 22 of the fixed body whose external diameter is less than or equal to the diameter of the internal wall 4 of the tank end piece in a manner such that the downstream portion 24 of the wall 22 can be introduced into the tank end piece 2, as represented in FIGS. 2 to 9. Advantageously, the downstream portion of the wall 22 is substantially complementary to the internal wall 4 of the tank end piece 2 in a manner such that the flow volume 18 is as large as possible in the vicinity of the outlet 16, which is defined by the orifice extending to the downstream end of the downstream portion 24 of the wall 22.

Upstream of the downstream portion 24, the diameter of the wall 22 is enlarged in a manner such that the fixed body 20 is able to accommodate the movable body 26 of a closure device 28 that makes it possible to control the flow of liquid through the outlet 16. The wall 30 of the movable body 26 of the closure device 28 defines the flow volume 18 upstream of the downstream portion 24 of the wall 22 of the fixed body 20. The inlet 14 of the container end, piece 1 is defined by the orifice extending to the upstream end of the wall 30 of the movable body 26. The downstream end of the wall 30 of the movable body 26 is in fluid communication with the upstream end of the downstream portion 24 of the wall 22 of the fixed body 20 in a manner so as to ensure the continuity of the flow volume 18. The external surface of the wall 30 of the movable body 26 is in sealing contact with the internal surface of the downstream portion 24 of the wall 22 of the fixed body 20 in the vicinity of the downstream end of the wall 30 of the movable body 26 and the upstream end of the downstream portion 24 of the wall 22 of the fixed body 20 in a manner so as to ensure the sealing of the flow volume 18. In order to do this, the external diameter of the wall 30 of the movable body 26 is substantially equal to the internal diameter of the downstream portion 24 of the wall 22 of the fixed body 20, at least in the vicinity of the downstream end of the wall 30 of the movable body 26. In addition, the seal is for example provided by an annular seal 32 extending between the wall 30 of the movable body 26 and the downstream portion 24 of the wall 22 of the fixed body 20.

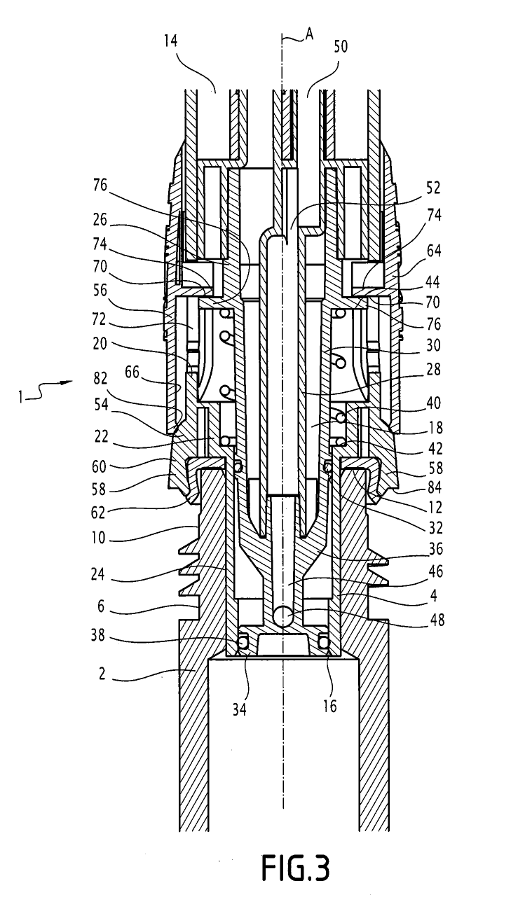

The closure device 28 in addition comprises a closure body 34 connected to the wall 30 of the movable body 26 by at least one arm 36 extending between the closure body 34 and the downstream end of the wall 30 of the movable body 26, as represented in FIGS. 3, 5 and 7. According to the embodiment shown in these figures, two arms 36 connect the closure body 34 to the wall 30 of the movable body 26. These arms 36 are sized so as to limit the disruption of the flow of liquid in the flow volume 18. The closure body 34 is substantially complementary to the downstream portion 24 of the wall 22 of the fixed body 20 in a manner such that the closure body 34 is able to close the downstream portion 24 and prevent the flow through the outlet 16, as represented in FIGS. 2, 3, 7 and 8. To this end, the closure body 34 has an external diameter that is substantially equal to the internal diameter of the downstream portion 24 of the wall 22 of the fixed body 20. In addition, an annular seal 38 extends for example around the closure body 34 so as to ensure a sealing contact between the closure body 34 and the downstream portion 24 in the closed position of the closure device 28, as it will now be described.

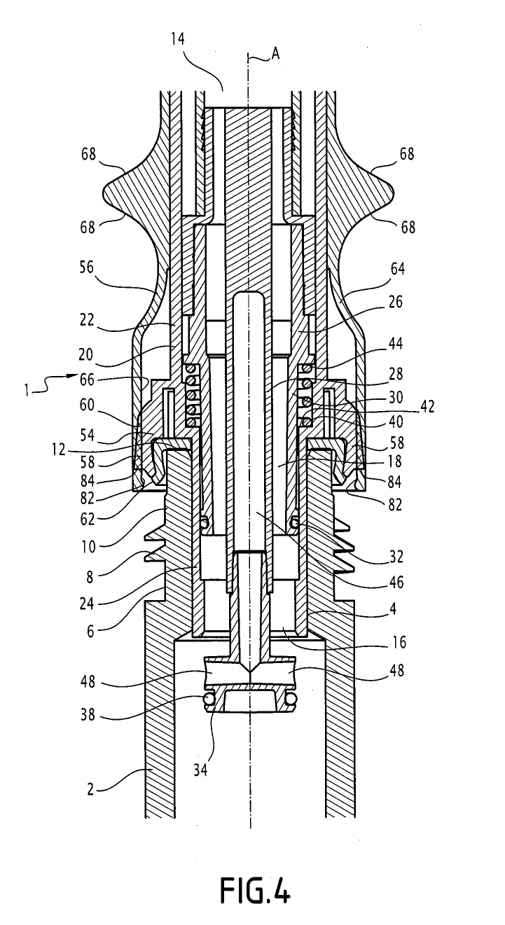

The movable body 26 is movable relative to the fixed body 20 between a closed position (FIGS. 2, 3, 7 and 8) and an open position (FIGS. 4, 5 and 9). In the closed position, the position of the movable body 26 is such that the closure body 34 extends in the downstream portion 24 of the wall 22 of the fixed body 20 and is in sealing contact therewith in the vicinity of the outlet 16 in a manner such that the flow of liquid through the outlet 16 is not possible. In the open position, the movable body 26 is moved in the downstream direction along the axis of flow A in a manner such that the closure body 34 is moved out of the downstream portion 24 of the wall 22 of the fixed body 20, which releases the flow of liquid through the outlet 16. Thus, the closure device 28 is movable in translational motion along the axis of flow A between the closed position and the open position relative to the fixed body 20.

According to one embodiment shown in the figures, a constraining element 40 constrains the movable body 26 to the closed position. The constraining element 40, for example a helical spring, is for example arranged around the wall 30 of the movable body 26 and bears against a radial bearing surface 42 of the fixed body 20 on the one hand and against a radial bearing surface 44 extending radially while projecting out from the wall 30 of the movable body 26 on the other hand. The constraining element 40 is compressed when the movable body 26 is in the open position in a manner so as to exert a restoring force towards the closed position on the movable body 26.

The actuation of the closure device 28 between the closed position and the open position will be described further on.

An aeration duct 46 extends through the flow volume 18 along the axis of flow A. The aeration duct 46 comprises at least one inlet 48 integrally formed with the closure body 34 and an outlet 50 intended to be connected to a aeration duct 49 provided in the container or in the flexible pipe 13. The inlet 48 is movable with the closure body 34 between the closed position, in which the inlet 48 is closed by the downstream portion 24 of the wall 22 of the fixed body 20, and the open position, in which the inlet 48 is moved out of the downstream portion 24 in a manner so as to be in fluid communication with the internal volume of the tank. In a known manner, the aeration duct 46 makes it possible to put in fluid communication the volume of air contained in the tank prior to the filling thereof with a volume of air extending above the level of liquid in the container in order to promote the flow of liquid between the container and the tank. In addition, the air inlet 48 serves the function of an anti-overflow device by stopping or slowing the flow of liquid when the inlet 48 is immersed in the liquid present in the tank. The aeration duct 46 is insulated from the flow volume 18 in a manner such that the liquid does not penetrate into this pipe.

According to the embodiment represented in FIGS. 2 and 4, the aeration duct 46 comprises two inlets 48 oppositely arranged in a manner such that the aeration duct 46 presents a T shaped form at its downstream end. Such an arrangement improves the circulation of air in the aeration duct 46. More particularly, the fact that two inlets 48 are provided makes it possible to ensure a gaseous exchange between the tank and the container whatever be the connection angle for connecting the container end piece on to the tank end piece.

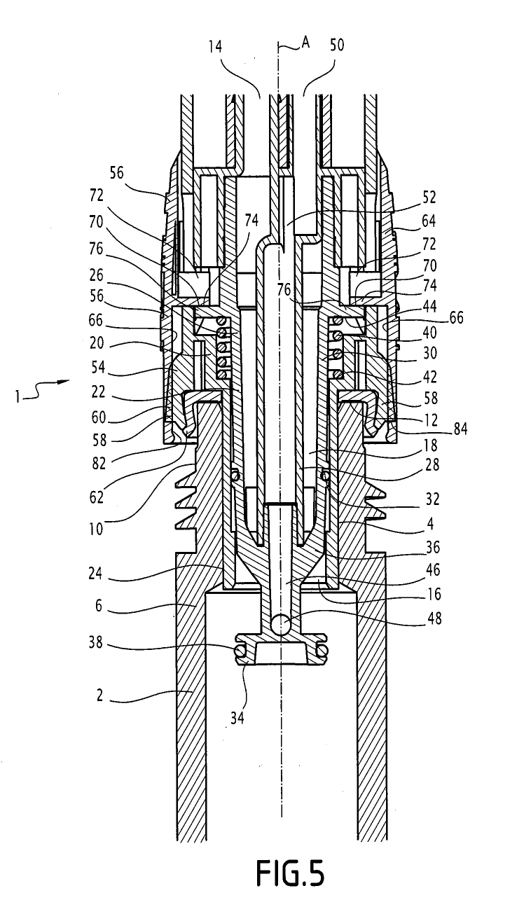

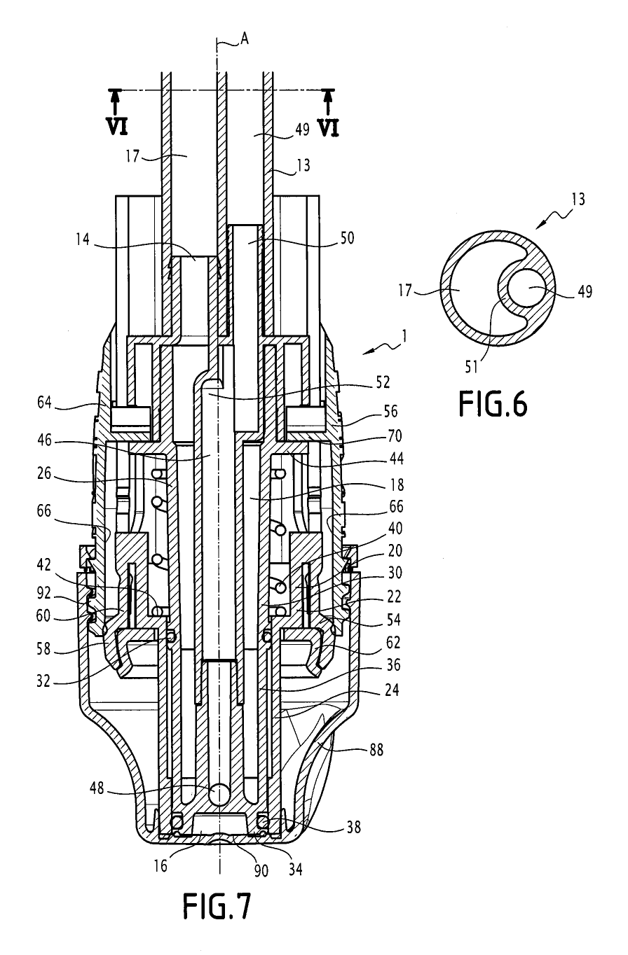

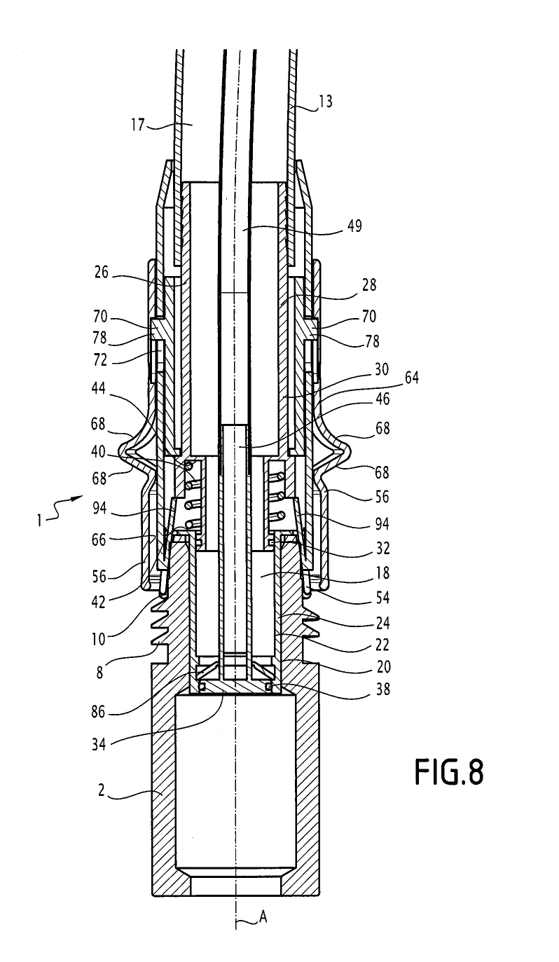

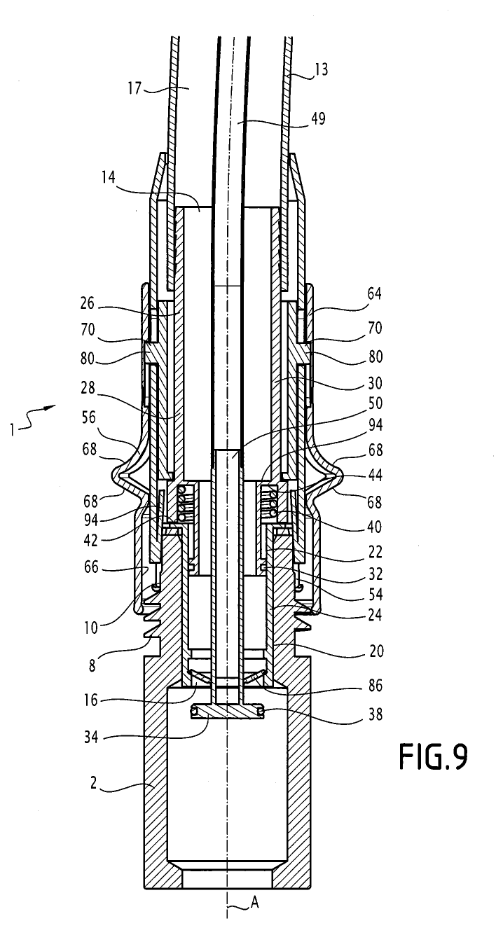

According to one embodiment represented in FIGS. 3 and 5, the aeration duct 46 extends substantially to the centre of the flow volume 18 from the downstream portion 24 of the fixed body 20 to a zone adjacent to the inlet 14. In this zone, the aeration duct 46 forms a bend 52 in a manner so as to extend against the wall 30 of the movable body 26 up to the inlet 14. Such an embodiment makes it possible to connect the aeration duct 46 to an aeration duct 49 provided for in the flexible pipe 13 that is coextruded with the flexible pipe 13, as represented in FIG. 6. According to this embodiment, the flexible pipe 13 comprises an internal wall 51 separating the liquid flow channel 17 and the aeration duct 49, it being possible for this internal wall 51 to be made integrally as one piece with the rest of the flexible pipe 13 by means of extrusion. Thus, the production of the flexible pipe is simplified because it does not necessitate the fabrication of a flexible pipe and a separate aeration duct followed by the subsequent introduction of the aeration duct into the flexible pipe, as it is the case in the embodiment represented in FIGS. 8 and 9, in which the aeration duct is provided at the centre of the flexible pipe 13.

The container end piece 1 in addition comprises a clamping device 54, that makes it possible to attach in a sealed manner the container end piece 1 to the tank end piece 2, and a control device 56 for controlling the clamping device 54.

When the container end piece 1 is attached on to the tank end piece 2, the clamping device 54 is arranged so as to cooperate in a sealed manner with the smooth section 10 of the external wall 6 of the tank end piece 2 in order to ensure a sealed connection between the container end piece 1 and the tank end piece 2.

The clamping device 54 extends around the fixed body 20 upstream of the downstream portion 24 of the fixed body 20 in the vicinity of the upstream end of the downstream portion 24. The clamping device 24 comprises at least two clamping arms 58, preferably oppositely arranged, that are movable between a spaced-apart position (FIGS. 2, 3, and 7) and a clamped position (FIGS. 4 and 5).

In the spaced apart position, the distance separating the clamping arms 58 and the external surface of the wall 22 of the fixed body 20 is such that the free end 12 and at least one portion of the smooth section 10 of the tank end piece 2 can be introduced between the clamping arms 58 and the external surface of the wall of the fixed body 20. In the clamped position, the clamping arms 58 are brought close to each other in a manner so as to be in abutment at least at one point against the smooth section 10 and to exert a clamping force on the smooth section 10. The movement between the spaced-apart position and the clamped position is a radial movement such that the clamping force is exerted along the radial direction. Such a clamping force makes it possible to ensure a robust and sealed attachment between the container end piece 1 and the tank end piece 2.

The clamping arms 58 have a form that is substantially flared from upstream to downstream, that is to say that the upstream end of each clamping arm 58 is closer to the wall 22 of the fixed body 20 than the downstream end of the clamping arm 58. The movement between the spaced-apart position and the clamped position is effected by drawing the downstream ends of the clamping arms 58 of the external wall 6 of the tank end piece 2 close to one another, that is to say by drawing the downstream ends of the clamping arms 58 close to each other along a radial direction.

According to the embodiment represented in the figures, each clamping arm 58 comprises an external portion 60 that is integrally formed as one piece with the wall 22 of the fixed body 20 and an internal portion 62 formed of a resilient material, for example of the elastomer type. The internal portion 62 is applied against the external portion 60 and is disposed between the external portion 60 and the wall 22 of the fixed body 20. Thus, the internal portion 62 forms the internal surface of the clamping arm 58 which is applied against the smooth section 10 of the external wall 6 of the tank end piece 2. Such an embodiment makes it possible to ensure a sealed contact between the clamping device 54 and the tank end piece 2 in the clamped position. In addition, the internal portion 62 is arranged so as to in abutment on the free end 12 of the tank end piece in order to ensure a complete seal between the container end piece 1 and the tank end piece 2. The internal portion 62 is for example arranged so as to ensure an annular sealing contact over the entire free end 12 of the tank end piece 2.

With respect to the external portion 60, it forms the external surface of the clamping arm 58 which is intended to cooperate with the control device 56 for moving the clamping device 54 between the spaced apart position and the clamped position, as will be described further on.

Each clamping arm 58 is arranged in a manner so as to be in a spaced-apart position when no constraint is exerted on the clamping arm 58. Thus, each clamping arm is substantially resilient in the radial direction.

By way of a variant, the clamping device 54 could comprise more than two oppositely arranged arms, for example four arms distributed around the fixed body 20. According to another variant, the clamping device 54 is formed by a flared skirt that is flared from upstream to downstream extending in a continuous manner around the fixed body 20. Such an embodiment provides for obtaining a continuous annular contact between the clamping device 54 and the smooth section 10 in the clamped position. This results in a more robust clamping and improved sealing being obtained.

The control device 56 is arranged so as to move the clamping device 54 between the spaced apart position and the clamped position and to exert a clamping force on the clamping device 54 in the clamped position. In order to do this, the control device 56 is movable between a retracted position (FIGS. 2, 3 and 7), in which the control device 56 exerts no force on the clamping device 54, and an active position (FIGS. 4 and 5), in which the control device 56 has moved the clamping device 54 into the clamped position and exerts a clamping force on the clamping device 54.

For this purpose, the control device 56 comprises a sleeve 64, or slider 64, disposed around the fixed body 20 and movable in translational motion along the axis of flow A relative to the fixed body 20 between a retracted position in which the sleeve 64 is spaced apart from the clamping device 54 and an active position in which the sleeve 64 exerts a radial bearing force on the clamping device 54 in order to place and retain the latter in the clamped position.

More particularly, the sleeve 64 comprises an internal surface 66 adapted so as to cooperate with the external surface formed by the external portion 60 of the clamping arms 58 so as to radially move the clamping arms 58 to the clamped position when the sleeve 64 slides downstream along the direction of the axis of flow A. Thus, the movement in translational motion along the direction of the axis of flow A of the sleeve 64 between the retracted position and the active position is transformed into the radial movement of the clamping arms between the spaced-apart position and the clamped position. The sleeve 64 is for example provided with actuating surfaces 68 on its external wall, that allow the user to actuate the control device 56 between the retracted position and the active position. The actuating surfaces 68 form, for example, ear-shaped elements on the external surface of the sleeve 64 and allow the user to grip the sleeve in order to move it in the upstream-downstream direction or in the downstream-upstream direction by positioning their fingers on both sides of the sleeve 64 so as to grip the ear-shaped elements formed by the actuating surfaces 68.

According to the embodiment represented in the figures, the control device 56 also makes it possible to actuate the closure device 28 between the closed position and the open position. In order to do this, the closure device 28 comprises at least one connecting element 70 connecting the movable body 26 to the sleeve 64 by passing through an opening 72 formed in the wall 22 of the fixed body 20, as represented in FIGS. 3, 5 and 7 to 9.

The connecting element 70 is formed by bearing surfaces provided respectively on the movable body 26 and on the sleeve 64 arranged so as to come into contact with each other when the sleeve 64 is moved in order for the contact surface provided on the sleeve 64 to press on the contact surface provided on the movable body 26 so as to move the movable body 26 between the closed position (FIGS. 3 and 8) and the open position (FIGS. 5 and 9). According to the embodiment represented in FIGS. 3 and 5, the contact surface of the sleeve 64 is formed by two contact arms 74 extending outward to project radially from the internal surface 66 of the sleeve 64, and the contact surface of the movable body is formed by two contact arms 76 extending outward to project radially from the external surface of the wall 30 of the movable body 26 facing the contact arms 74 of the sleeve 64. According to the embodiment represented in FIGS. 8 and 9, the contact surfaces are formed between two pins 78 extending radially from the external surface of the wall 30 of the movable body 26 and grooves provided in the sleeve 64 and in which the pins 78 are introduced.

According to this embodiment, the control device 56 is movable to a flow position (FIGS. 3, 5 and 9) in a manner so as to move the closure device 28 into the open position. In other words, the movement of the control device 56 to the flow position causes the moving of the closure device 28 to the open position. The flow position extends beyond the active position in relation to the retracted position, that is to say that along the upstream-downstream direction, the control device 56 is successively movable between the retracted position, the active position and the flow position. In the retracted position, the control device 56 interacts neither with the clamping device 54 nor with the closure device 28. In the active position, the control device 56 only interacts with the clamping device 54, in order to place it and retain it in a clamped position. In the flow position, the control device 56 interacts with the clamping device 54, in order to retain it in a clamped position, and with the closure device 28 in order to move it to the open position. This signifies that the container end piece 1 is arranged in a manner such that the closure device 28 can be placed in the open position only when the container end piece 1 is attached in a sealed manner to the tank end piece 2. It thus becomes possible to prevent the flow of liquid from taking place while the container end piece 1 is not attached on to the tank end piece 2.

The control device 56 in addition comprises a locking device for locking the control device 56 in the flow position so that the user would not have to maintain a pressing force on the control device 56 during the operation of transferring of the liquid between the container and the tank. The locking device comprises for example a shoulder 82 extending outward to project radially from the internal surface 66 of the sleeve 64 to the downstream end of the sleeve 64 and a retaining surface 84 extending radially from the downstream end of the clamping arms 58. The sizing of the sleeve 64 and the clamping arms 58 is such that, when the control device 56 reaches the flow position, the shoulder 82 cooperates with the retaining surfaces 84 of the clamping arms 58 in order to block the relative movement of the control device 56 relative to the fixed body 20 and thereby ensure the retaining of the closure device 28 in the open position. Thus, the locking device is movable between an unlocked position, when the control device 56 moves between the retracted position and the flow position, and a locked position, when the control device 56 reaches the flow position, the locking device being arranged so as to retain the control device 56 in the flow position when it is in the locking position. The sizing is also such that the shoulder 82 is able to disengage from the retaining surfaces 84 when a user pulls on the sleeve 64 through the actuating surfaces 68 in the downstream-upstream direction in order to cause the closure device 28 to pass into the closed position.

Such a locking device also provides the means to inform the user of the proper connection of the container end piece on the tank end piece. Indeed, the passing of the shoulder 82 into the position in which it cooperates with the retaining surfaces causes a click that is felt by the user through the sleeve 64. This click thus informs the user that the connection has been effected correctly.

According to another embodiment, the actuation of the closure device 28 could be dissociated from the actuation of the clamping device 54 by providing for two control devices, one for the movement of the clamping device 54 and the other for the movement of the closure device 28.

According to the embodiment represented in FIGS. 8 and 9, which could also be applied to the other embodiments, a bistable element 86 is provided between the movable body 26 and the fixed body 20 in order to give the user information on the position occupied by the closure device 28. Such a bistable element 86 is provided in order to have a stable closed position in the closed position of the closure device 28 (FIG. 8) and a stable open position in the open position of the closure device 28 (FIG. 9). Between its two positions, the bistable element 86 tends to bring the closure device 28 back to the closed position when the bistable element 86 is between the stable closed position and an intermediate position and tends to bring the closure device 28 back to the open position when the bistable element 86 is between the intermediate position and the stable open position. Thus, the user feels the force applied by the bistable element 86 on the closure device 28 when the latter moves towards the open position or towards the closed position, which gives it information on the position of the closure device 28. Such a bistable element is for example formed by an elastic washer extending around the external wall of the movable body 26 to the internal wall of the fixed body 20. In each of the stable positions, the washer has a frustoconical shaped form. More particularly, in the stable closed position, the small base of the washer, formed by the end of the washer extending around the external wall of the movable body 26, extends upstream of the large base, formed by the end of the washer extending over the internal wall of the fixed body 20. In the stable open position, the small base of the washer extends downstream of the large base of the washer. In the intermediate position, the washer is substantially planar. By way of a variant, a plurality of bistable elements, for example formed by elastic blades, may be provided between the movable body 26 and the fixed body 20, these blades being inclined in relation to the axis of flow A in the stable positions and being substantially perpendicular to the axis of flow A in the intermediate position.

The container end piece 1 in addition comprises a locking device intended to prevent unintentional movement of the closure device 28 in the open position so as to prevent any leakage from the container when the container end piece 1 is not attached on to the container 2.

According to the embodiment represented in FIGS. 2 to 7, the locking device is formed by a cap 88 (represented in FIG. 7), which is screwed on to the sleeve 64 and which includes a locking surface 90 applied against the closure body 34 when the cap 88 is screwed on to the sleeve 64. Thus, the closure device is not able to move to the open position when the cap 88 is screwed on to the sleeve 64. To this end, the external surface of the sleeve 64 is thus then provided with a thread 92 that makes it possible to screw the cap 88 on the sleeve 64. Thus, the user must remove the cap 88 from the container end piece 1 in order to actuate the closure device 28. According to this embodiment, a strap connecting the cap to sleeve (not shown) may be provided so as to retain the cap 88 when it is unscrewed from the sleeve 64 in order to prevent the loss of this cap. According to this embodiment, the locking device is in the locking position when the cap 88 is screwed on to the sleeve 64 and in the unlocking position when the cap 88 is removed from the sleeve 64.

According to the embodiment represented in FIGS. 8 and 9, the locking device comprises at least one locking tab 94 provided between the fixed body 20 and the movable body 26. The locking tab 94 is integrally formed with the fixed body 20 and is movable between a locking position (FIG. 8), in which the locking tab 94 interferes with the movable body 26 and prevents its movement to the open position, and an unlocking position (FIG. 9), in which the locking tab does not interfere with the movable body 26 and allows its movement to the open position. The locking tab 94 extends for example between a downstream end of the upper part of the fixed body 20 and the downstream end of the movable body 26 in the locking position in a manner such that it prevents the moving of the movable body 26 to the open position. When the container end piece 1 is fitted on to the tank end piece 2, the smooth section 10 is arranged so as to move the locking tab 94 against the wall 22 of the fixed body 20 in order to disengage the latter from the downstream end of the movable body 26 and thus allow movement of the movable body 26 to the open position, as shown in FIG. 9. The locking tab 94 has an elastic behaviour in a manner such that it returns into the locking position when the container end piece 1 is removed from the tank end piece 2 and the closure device 28 returns to the closed position under the effect of the constraining element 40. According to the embodiment represented in FIGS. 8 and 9, the locking device comprises two locking tabs 94 that are diametrically oppositely arranged.

Thus, according to this embodiment, the closure device 28 can move to the open position only if the container end piece 1 is fitted on to the tank end piece 2, which prevents any inadvertent manipulation of the container end piece 1.

The operation of the connection assembly will now be described.

When the tank is to be filled with the liquid contained in the container, the user uses the container end piece 1 so as to connect it to the tank end piece 2 and thus enable a transfer of the liquid from the container to the tank.

In the embodiment where the locking device is formed by a cap 88, the user removes the cap 88 in a manner so as to disengage the closure body 34.

The user then fits the container end piece 1 on to the tank end piece 2 by holding the container end piece 1 by the sleeve 64, for example by the actuating surfaces 68. When the container end piece 1 is fitted on the tank end piece 2, the smooth section 10 of the tank end piece is introduced between the external surface of the downstream portion 24 of the fixed body 20 and the internal surface of the clamping arms 58. When the free end 12 of the tank end piece 1 comes into contact with the internal portion 62 of the clamping arms 58, a support in the upstream-downstream direction of the user on the sleeve 64 causes a movement of the control device 56 from the retracted position to the active position, which causes a movement of the clamping device 54 from the spaced apart position to the clamped position. The container end piece 1 is thus attached to the tank end piece 2 in a sealed and robust manner. It will be noted that the attachment of the container end piece 1 is effected on the smooth section 10 of the tank end piece by means of a movement in translational motion. Thus, the user does not have to turn the container end piece relative to the tank end piece, as is the case when the end pieces are screwed together, which simplifies the attachment of the end pieces. In addition, the container end piece does not need to be oriented in a particular fashion in relation to the tank end piece in order for the connection to be made. In addition, the container end piece 1 can be attached on to several types of tank end pieces without having to size a thread of the container end piece relative to a thread of the tank end piece. Finally, the tank end piece 2 can be simplified since it does not need to include specific means of cooperation with the container end piece in order to ensure the attachment of the connection assembly.

A further movement in the upstream-downstream direction by the user causes the moving of the control device 56 from the active position to the flow position, which causes the moving of the closure device 28 from the closed position to the open position. The user is then informed that the flow position is reached thanks to the clicking caused by the locking device and/or thanks to the bistable element 86.

Thus, the user can, with a single upstream-downstream operation on the sleeve 64, fit the container end piece 1 on to the tank end piece 2, attach in a sealed manner the container end piece 1 on to the tank end piece 2, and initiate the transfer of the liquid from the container to the tank by causing the passing of the closure device 28 from the closed position to the open position. This actuation can be performed with one single hand by the user. The transition from the closed position to the open position can only be brought about once the container end piece 1 is attached on to the tank end piece 2. Thus, improper handling of the container end piece 1 could not cause leakage of the liquid. In order for the closure device 28 to pass into the open position without the container end piece 1 being attached to the tank end piece 2, it would be necessary for the user themselves to have pressed on the internal portion 62 of the clamping arms 58, which is highly unlikely because this part is very difficult to access from the exterior of the container end piece 1 and this operation thus being particularly complicated could only take place in an intentional and deliberate manner. Thus, the risk of involuntary opening of the container end piece 1 is eliminated.

During the transfer, the user can release the control device 56 which remains in its flow position by means of the locking device described here above, which retains the control device 56 in the flow position and the closure element 28 in the open position against the force exerted by the constraining element 40. The flow of liquid from the container to the tank is effected rapidly thanks to the aeration ducts 46 and 49.

When the transfer is complete, with it stopping for example automatically when the air inlet 48 is immersed in the liquid in the tank, the user needs only to pull on the control device 56 in the downstream-upstream direction, in order to successively place the closure device 28 in the closed position, undo the attachment of the container end piece 1 from the tank end piece 2, and remove the container end piece 1. The closure device 28 returns automatically into its closed position under the effect of the constraining element 40 when the locking device is unlocked by the disengagement of the shoulder 82 from the retaining surfaces 84.

It will be noted that the volume occupied by the parts of the end piece extending into the internal volume of the container end piece 1 is fitted on the tank end piece 2 is released upon the disconnecting of the container end piece 1, which releases a volume in the tank end piece 2 and thus prevents any overflow of the liquid transferred outside the tank even when the latter is fully filled.

The user then replaces the cap 88, which thus effectively serves to prevent leakage when the container is not being used, for example in case of any shock impacts against the container or when a heavy object is placed on it. Indeed, the cap 88 prevents any movement of the closure device 28 to the open position even when an overpressure is applied within the container.

The functioning of the container end piece 1 according to the embodiment shown in FIGS. 8 and 9 is substantially similar except that there is no need to remove a cap in order to use the end piece. Indeed, in this case, the locking device passes into its unlocking position during the process of the container end piece 1 being press fitted on to the tank end piece 2, which further simplifies the use of the container end piece 1.

As previously indicated, the container end piece 1 described here above may be attached on to various different containers of variable capacity. These may be for example jerry can type containers. Such a container defines an internal volume that is adapted so as to contain the liquid and an outlet opening through which the liquid is able to flow out of the internal volume. The outlet opening is for example formed by the free end of a neck.

For containers of small capacity, for example 2 L or less, the container end piece 1 may be directly attached on to the neck of the container, for example by screwing. In this case, the inlet 14 of the tank end piece 1 is in direct fluid communication with the internal volume of the container by way of the outlet opening. For containers of larger capacities, for example 5 L, the container end piece 1 is connected to the container by means of a flexible pipe 13 as previously described. This makes it possible to not have to lift the container during the liquid transfer operation and thereby allows the user to avoid carrying heavy loads. The pipe 13 is for example, on the one hand, clip-fastened on to the container end piece 1 and on the other hand, screwed on the neck of the container. In this case, the inlet 14 of the container end piece is in fluid communication with the internal volume of the container by way of the flexible pipe 13.

While the invention has been illustrated and described in connection with currently preferred embodiments shown and described in detail, it is not intended to be limited to the details shown since various modifications and structural changes may be made without departing in any way from the spirit of the present invention. The embodiments were chosen and described in order to best explain the principles of the invention and practical application to thereby enable a person skilled in the art to best utilize the invention and various embodiments with various modifications as are suited to the particular use contemplated.

What is claimed is:

1. A liquid container end piece intended to be fitted on a liquid tank end piece in order to transfer in a sealed manner the liquid from the container to the tank, the said container end piece comprising:
an inlet intended to be connected in a sealed manner to the liquid container;
an outlet intended to be connected in a sealed manner to the tank end piece, the said outlet being in fluid communication with the inlet;
a movable closure device that is movable between a closed position, in which the closure device prevents the flow of liquid through the outlet, and an open position, in which the closure device allows the flow of liquid through the outlet;
a sealed connection device for sealingly connecting the container end piece on to the tank end piece that is intended to cooperate in a sealed and detachable manner with the tank end piece;
wherein the connecting device comprises:
a clamping device around the tank end piece that is movable between a spaced-apart position, in which the container end piece can be inserted around an external wall of the tank end piece, and a clamped position, in which the clamping device co-operates in a sealed manner with the external wall of the tank end piece;
a control device that is actuable between a retracted position, in which the control device does not cooperate with the clamping device, and an active position, in which the control device exerts a clamping force on the clamping device in its clamped position, the movement of the control device from the retracted position to the active position causing the moving of the clamping device from the spaced-apart position to the clamped position.

2. A container end piece according to claim 1, in which the outlet extends along an axis of flow, the movement of the clamping device between the spaced apart position and the clamped position being effected along a radial direction, that is substantially perpendicular to the direction of the axis of flow.

3. A container end piece according to claim 2, in which the control device moves in translational motion along the axis of flow between the retracted position and the active position.

4. A container end piece according to claim 1, in which the control device is connected to the closure device, the control device being in addition actuable in a flow position beyond the active position in relation to the retracted position, the movement of the control device in the flow position causing the closure device to move from the closed position to the open position.

5. A container end piece according to claim 4, in which the control device comprises a locking device for locking the control device in the flow position, the locking device being movable between an unlocked position when the control device moves between the retracted position and the flow position, and a locked position when the control device reaches the flow position, the locking device being arranged so as to retain the control device comprises a locking device for locking the control device.

6. A container end piece according to claim 1, in which the clamping device comprises at least two clamping arms, spaced apart from each other in the spaced-apart position and drawn close to one another in the clamped position, each clamping arm comprising of an internal surface adapted so as to be in sealed contact with the external wall of the tank end piece in the clamped position, and an external surface on which the control device slides while moving from the retracted position to the active position in a manner so as to draw the clamping arms close to one another during this movement.

7. A container end piece according to claim 1, comprising a wall extending between the inlet and the outlet and defining a portion of a liquid flow volume, the closure device comprising a movable body provided with a closure body, the movable body being movable in relation to the said wall between the closed position in which the closure body is in sealing contact with the wall and the open position, in which the closure body is disengaged from the wall in a manner such that the liquid is able to flow through the outlet.

8. A container end piece according to claim 7 comprising an aeration duct extending through the flow volume and insulated from it, the said duct comprising at least one air inlet integrally formed with the closure body in a manner such that the air inlet is closed in the closed position of the closure device and is in communication with the exterior in the open position of the closure device.

9. A container end piece according to claim 1, in addition comprising a locking device, that is movable between a locking position, in which the locking device prevents the moving of the closure device from the closed position to the open position, and an unlocking position, in which the closure device is able to move between the open and closed positions.

10. A container end piece according to claim 9, in which the locking device comprises a cap that is fixed on to a wall of the container end piece and prevents the moving of the closure device in the locking position and separated from the said wall in the unlocking position.

11. A container end piece according to claim 9, in which the locking device comprises at least one locking tab, the said locking tab being movable between a locking position, in which it interferes with the closure device and prevents its movement, and an unlocking position, in which the locking tab does not interfere with the closure device and allows its movement, the moving of the locking tab from the locking position to the unlocking position being brought about by the introduction of the container end piece on the tank end piece.

12. A connection assembly for connecting a liquid container to a liquid tank, comprising a container end piece according to claim 1 and a tank end piece comprising an external wall of which at least one section is substantially smooth, the container end piece being attached in a sealed manner to the tank end piece by the cooperation of the clamping device with the smooth section of the external wall when the said clamping device is in the clamped position.

13. A liquid container that defines an internal volume that is adapted so as to contain a liquid and comprises an outlet opening through which the liquid can flow out of the internal volume, the said container comprising a container end piece according to claim 1, whereof the inlet is in fluid communication with the internal volume of the container by way of the outlet opening.

14. A liquid container according to claim 13, comprising a neck defining the outlet opening, the container end piece being fixed directly on to the said neck or being connected to the said neck by means of a flexible pipe.
